(19) United States
(12) Patent Application Publication
(10) Pub. No.: US 2025/0044080 A1
(43) Pub. Date: Feb. 6, 2025

(54) GOLF LAUNCH MONITOR AND TARGET ALIGNMENT METHOD OF GOLF LAUNCH MONITOR

(71) Applicant: Vieworks Co., Ltd., Anyang-si (KR)

(72) Inventors: Joonggeun KIM, Hwaseong-si, Gyeonggi-do (KR); Taejun LIM, Incheon (KR); Seung Hyun KIM, Seongnam-si, Gyeonggi-do (KR)

(21) Appl. No.: 18/784,210

(22) Filed: Jul. 25, 2024

(30) Foreign Application Priority Data
Aug. 4, 2023 (KR) 10-2023-0102257

(51) Int. Cl. G01B 11/27; A63B 24/00; A63B 102/32

(52) U.S. Cl. CPC G01B 11/272; A63B 24/0003; A63B 2102/32

(57) ABSTRACT

Described are a golf launch monitor and a target alignment method of the golf launch monitor. A target alignment method of a golf launch monitor using an alignment jig including a two-dimensional alignment mark placed in front of the golf launch monitor includes: (a) acquiring a first image and a second image including the alignment mark with a first image sensor and a second image sensor, respectively; (b) detecting, by a processor, the alignment mark in the first image and the second image, respectively; and (c) calculating, by the processor, an aimed target line according to the alignment jig by using the detected alignment mark and calibration parameters of the first image sensor and the second image sensor.

### CROSS-REFERENCE TO RELATED APPLICATIONS

This application claims priority to and the benefit of Korean Patent Application No. 10-2023-0102257 filed in the Korean Intellectual Property Office on Aug. 4, 2023, the entire contents of which are incorporated herein by reference.

### TECHNICAL FIELD

The present invention relates to a golf launch monitor and a target alignment method of the golf launch monitor. More specifically, the present invention relates to a golf launch monitor that monitors a trajectory of a golf ball and a target alignment method of the golf launch monitor.

### BACKGROUND ART

A golf launch monitor is a system that tracks or estimates the flight of a golf ball after impact and presents a result of the track or estimation to a user. Indoor golf simulators, popularly known as screen golf, commonly use stereo cameras to calculate a trajectory of a golf ball. These indoor golf simulators may also be considered golf launch monitors in a broad sense.

However, recently, there appear golf launch monitors that are portable and useable in a variety of environments, both indoors and outdoors. These golf launch monitors typically utilize radar technology or high-speed camera technology. In addition to the trajectory of the golf ball, golf launch monitors are also capable of providing a variety of other information about the golf swing, such as club speed, ball speed, attack angle, and club path.

However, in order to accurately monitor the launch of a golf ball, it is necessary to align the golf launch monitor along a target direction in which the golfer intends to hit the golf ball.

For example, Korean Patent No. 10-2248980 discloses a golf ball launch monitor target alignment method that aligns the azimuth by using an alignment stick. In the prior art, a golfer aligns a rod-shaped alignment stick in a direction desired by the golfer, photographs the alignment stick by using two image sensors of a launch monitor, and detects an edge component of the alignment stick in the images photographed by the image sensors, respectively. Image coordinates of the detected edges are converted to three-dimensional spatial coordinates by using pre-calculated calibration parameters of each image sensor, and the direction of the alignment stick in three-dimensional space is calculated. In this way, in determining the direction of the alignment stick in the three-dimensional space, the success of detecting the edges configuring the alignment stick in the image in which the alignment stick is photographed has a great influence.

For example, when the alignment stick is photographed in an even environment, such as an indoor environment, with a flat floor surface and no obstacles that may obscure the alignment stick, it is relatively easy to detect the edges that configure the alignment stick in the image.

However, in an outdoor environment, such as an actual golf course, when the alignment stick is placed on the ground, external obstacles, such as grass, may obscure the alignment stick. Therefore, when the alignment stick is photographed in the outdoor environment, the probability of detecting the edges configuring the actual alignment stick in the image decreases, and the probability of detecting the edges of other external obstacles acting as noise increases. This reduces the detection accuracy in determining the direction of the alignment stick in three-dimensional space.

### PRIOR ART LITERATURE

### Patent Document

(Patent Document 1) Korean Patent No. 10-2248980

### SUMMARY OF THE INVENTION

The present invention has been made in an effort to provide a target alignment method of a golf launch monitor that is capable of minimizing alignment errors caused by an external environment in an indoor or outdoor environment, and a golf launch monitor that performs the same.

An exemplary embodiment of the present invention provides a target alignment method of a golf launch monitor using an alignment jig including a two-dimensional alignment mark placed in front of the golf launch monitor, the target alignment method including: (a) acquiring a first image and a second image including the alignment mark with a first image sensor and a second image sensor, respectively; (b) detecting, by a processor, the alignment mark in the first image and the second image, respectively; and (c) calculating, by the processor, an aimed target line according to the alignment jig by using the detected alignment mark and calibration parameters of the first image sensor and the second image sensor.

In the embodiment, the alignment jig may include a base that is seated on the ground and an alignment panel fixed to an upper portion of the base and including the alignment mark.

Further, the alignment mark may be formed of a reflective material or a reflective sheet.

The target alignment method may further include (d) calculating, by the processor, a target alignment offset based on a difference between a direction of the aimed target line and a reference target line of the golf launch monitor.

Further, the alignment mark may have a predetermined polygonal shape, and the operation (b) may be performed by detecting at least two straight lines forming the polygon and an intersection point of the two straight lines, and calculating three-dimensional coordinates of the intersection point.

Further, the alignment mark may be formed of a set of a plurality of line segments or a plurality of points.

Another embodiment of the present invention provides a golf launch monitor using an alignment jig including a two-dimensional alignment mark placed in front of the golf launch monitor, including: a first image sensor and a second image sensor configuring a stereo camera; and a processor configured to perform the following steps; (a) acquiring a first image and a second image including the alignment mark with a first image sensor and a second image sensor, respectively; (b) detecting the alignment mark in the first image and the second image, respectively; and (c) calculating an aimed target line according to the alignment jig by using the detected alignment mark and calibration parameters of the first image sensor and the second image sensor.

According to the present invention, by using the alignment jig with a polygonal shape, it is possible to more accurately align the golf launch monitor in a target direction, regardless of indoors or outdoors.

The foregoing summary is illustrative only and is not intended to be in any way limiting. In addition to the illustrative aspects, exemplary embodiments, and features described above, further aspects, exemplary embodiments, and features will become apparent by reference to the drawings and the following detailed description.

### BRIEF DESCRIPTION OF THE DRAWINGS

FIG. 1 is a diagram illustrating an example of a target direction alignment of a golf launch monitor.

FIG. 2 is a block diagram illustrating a configuration of a golf launch monitor according to an embodiment of the present invention.

FIG. 3 is a diagram illustrating an alignment jig used to perform target alignment of the golf launch monitor according to the embodiment of the present invention.

FIG. 4 is a diagram illustrating an example of a disposition configuration for performing target alignment of the golf launch monitor according to the embodiment of the present invention.

FIG. 5 is a diagram illustrating an example of image processing for performing target alignment of the golf launch monitor according to the embodiment of the present invention.

FIG. 6 is a flowchart illustrating a target alignment method of the golf launch monitor according to an embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The present invention may have various modifications and exemplary embodiments and thus specific exemplary embodiments will be illustrated in the drawings and described. However, it is not intended to limit the present invention to the specific exemplary embodiments, and it will be appreciated that the present invention includes all modifications, equivalences, or substitutions included in the spirit and the technical scope of the present invention. However, in the description of the present invention, when a detailed description of a related publicly known function or constituent element is determined to unnecessarily make the subject matter of the present invention unclear, the detailed description thereof will be omitted.

Terms including an ordinary number, such as first and second, are used for describing various constituent elements, but the constituent elements are not limited by the terms. The terms are used only to discriminate one constituent element from another constituent element.

Terms used in the present invention are used only to describe specific exemplary embodiments, and are not intended to limit the present invention. The terms used in this specification have been selected as currently widely used general terms as much as possible while considering the functions in the present disclosure, but this may vary depending on the intention or precedent of the engineer in the related field, the emergence of new technology, and the like. In addition, in specific cases, there are also terms arbitrarily selected by the applicant, and in this case, the meaning will be described in detail in the description of the relevant invention. Accordingly, the term used in the present disclosure should be defined based on the meaning of the term and the entire contents of the present disclosure, simply not a name of the term.

Singular expressions used herein include plurals expressions unless they have definitely opposite meanings in the context. In the present invention, it will be appreciated that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance.

Hereinafter, exemplary embodiments according to the present invention will be described in detail with reference to the accompanying drawings, and the same or corresponding constituent elements are denoted by the same reference numerals regardless of a sign of the drawing, and repeated description thereof will be omitted.

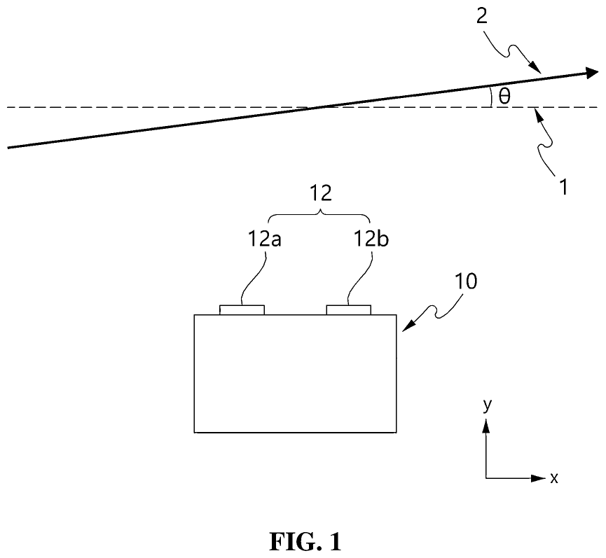

FIG. 1 is a diagram illustrating an example of a target direction alignment of a golf launch monitor.

In FIG. 1, the X-Y plane represents the ground on which a golf launch monitor 10 is placed.

The golf launch monitor 10 may include at least two image sensors 12 including a first image sensor 12a and a second image sensor 12b. The first image sensor 12a and the second image sensor 12b may be disposed in a horizontal direction or disposed in a vertical direction. In the embodiment, as illustrated in FIG. 1, the first image sensor 12a and the second image sensor 12b may be disposed horizontally along the X-axis direction. Depending on the case, the first image sensor 12a and the second image sensor 12b may also be disposed vertically along the Z-axis direction perpendicular to the X-Y plane, and the first image sensor 12a and the second image sensor 12b may be provided on the golf launch monitor 10 in a direction or position other than the horizontal direction or vertical direction.

Based on the images acquired by the first image sensor 12a and the second image sensor 12b, the golf launch monitor 10 may calculate a target direction.

Referring to FIG. 1, a reference target line 1 may be set based on the disposition of the first and second image sensors 12a and 12b provided in the golf launch monitor 10. In one embodiment, the reference target line 1 may be determined based on the disposition characteristics of the image sensors 12. For example, the reference target line 1 may be set by mapping between three-dimensional spatial coordinates and two-dimensional image coordinates through a camera calibration process of the image sensor 12. In other embodiments, the reference target line 1 may be set to a virtual line or direction set by the golf launch monitor 10 based on an output value of a tilt sensor provided in the golf launch monitor 10. An aimed target line 2 is a target line set by the user. The aimed target line 2 forms an angle θ with the reference target line 1, and the angle θ may be understood as an alignment offset of the aimed target line 2 with respect to the reference target line 1.

The present invention is characterized in that the user sets an aimed target direction using an alignment jig 30 described later, and the golf launch monitor 10 acquires an image of the alignment jig 30 with the image sensor 12, and then calculates the aimed target line 2 in three-dimensional space by using two-dimensional coordinates of the acquired image and calibration parameters of the image sensor 12. In one embodiment, the golf launch monitor 10 may calculate the alignment offset θ, which is the angle that the reference target line 1 and the aimed target line 2 form in three-dimensional space by using the image of the alignment jig 30 acquired by the image sensor 12.

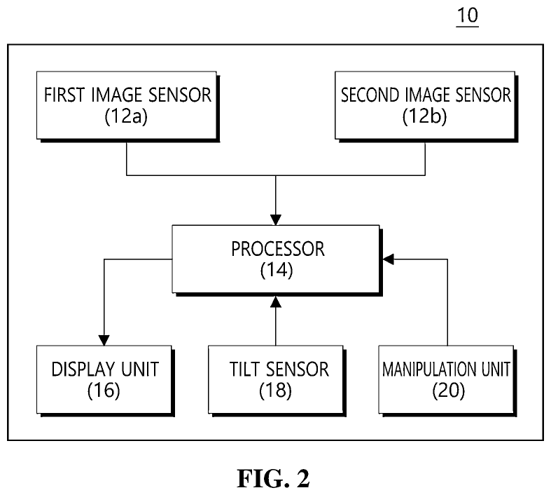

FIG. 2 is a block diagram illustrating a configuration of the golf launch monitor according to an embodiment of the present invention.

The golf launch monitor 10 may include the first image sensor 12a and the second image sensor 12b as described above, a processor 14 for performing target alignment processing by calculating an aimed target line by using images acquired from the first image sensor 12a and the second image sensor 12b, a display unit 16 for presenting information to a user, a tilt sensor for sensing a posture in which the golf launch monitor 10 is placed, and a manipulation unit 20 for manipulation by a user.

The first and second image sensors 12a and 12b each acquire images within a field of view, and the first and second image sensors 12a and 12b may configure stereo cameras. In addition to acquiring images for target alignment, the first and second image sensors 12a and 12b may photograph the golf ball at a high speed upon hitting of the golf ball.

The display unit 16 may display information in a visual, audible, or tactile manner. In one embodiment, the display unit 16 may be configured as a visual display device. The display unit 16 may be formed of a light emitting device, such as a Light Emitting Diode (LED). The display unit 16 may be formed of a speaker. Further, the display unit 16 may include a vibration generating element. In one embodiment, the display unit 16 may display information related to target alignment (e.g., start of target alignment, requirement to install an alignment jig to align the target, completion of alignment jig recognition, and completion of target alignment), whether the golf ball is recognized when the golf ball is placed on the ground for hitting, information about the flight of the golf ball upon hitting the golf ball (e.g., direction of flight of the golf ball, trajectory of the golf ball, driving distance of the golf ball, speed of the golf ball, speed of the golf club head, and angle of attack).

A tilt sensor 18 senses the tilt of the golf launch monitor 10 while it is placed on the ground. Based on a sensing value of the tilt sensor 18, information about the posture of the golf launch monitor 10 placed on the ground may be calculated.

The manipulation unit 20 is for inputting user's manipulations, and may include an input device, such as a mechanical switch or button, or a touch screen.

The processor 14 may function as a control unit of the golf launch monitor 10. Specifically, the processor 14 may control the operation of the golf launch monitor 10 via inputs from the manipulation unit 20. The processor 14 may calculate posture information of the golf launch monitor 10 based on the sensing value of the tilt sensor 18. The processor 14 may perform target alignment based on the images acquired by the first and second image sensors 12a and 12b. The processor 14 may calculate flight information of the golf ball from the images of the golf ball and/or the images of the golf club head acquired by the first and second image sensors 12a and 12b. The processor 14 may display the request to the user, the internal processing progress status of the processor 14, and/or the results of the processing through the display unit 16.

Further, the golf launch monitor 10 may additionally include a lighting unit (not shown), and the lighting unit may emit light toward the alignment jig 30 during target alignment.

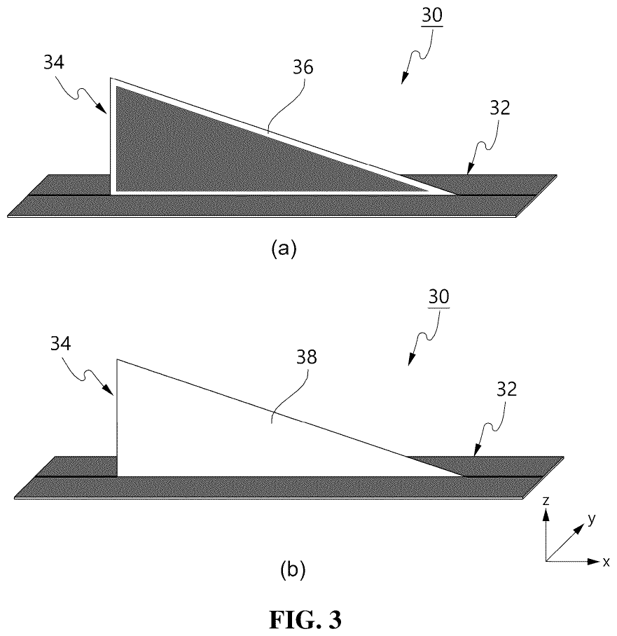

FIG. 3 is a diagram illustrating an alignment jig used to perform target alignment of the golf launch monitor according to the embodiment of the present invention.

The alignment jig 30 for target alignment of the golf launch monitor according to the present invention is illustrated in FIG. 3.

In the embodiment, the alignment jig 30 includes a base 32 and an alignment panel 34 fixed to the base 32.

The base 32 may support the alignment jig 30 against the ground. The base 32 may be in the shape of a plate, but in some cases may be in the shape of a rod fixed to the ground, and may be implemented in various configurations or shapes other than a plate or a rod, as long as the alignment panel 34 may be self-supportably supported on the ground.

The alignment panel 34 may have two-dimensional and predetermined shaped alignment marks 36 and 38 on a surface thereof. The appearance of the alignment panel 34 may be the same as the outer lines of the alignment marks 36 and 38, but may be different from the outer lines of the alignment marks 36 and 38. For example, in (a) of FIG. 3, the alignment mark 36 is formed as lines of a triangle, and in (b) of FIG. 3, the alignment mark 38 is formed as a solid-type triangle, and the appearance of the alignment panel 34 is formed along the outline of the alignment mark 36 along the lines of triangle or the alignment mark 38 in the form of the solid triangle, but it is also possible to configure the appearance of the alignment panel 34 as a square rather than a triangle.

Further, although the alignment marks 36 and 38 are formed as triangles (e.g., right-angled triangles), it may be possible to form the alignment marks 36 and 38 as polygons other than a triangle, such as a square or a pentagon.

In the embodiment, the lines of the triangle configuring the alignment mark 36 or the solid triangle configuring the alignment mark 38 may be formed using a reflective sheet or reflective paint. By forming the alignment marks 36 and 38 with a highly reflective substance or material, the alignment marks 36 and 38 may be more easily identified in the image acquired by the image sensor 12.

By disposing the alignment panel 34, which includes alignment marks 36 and 38 formed by applying a reflective material or attaching a reflective sheet, in a direction perpendicular to the ground rather than on the ground, the alignment marks 36 and 38 are positioned in front of the image sensor 12. By increasing the amount of light reflected from the alignment marks 36 and 38, a relatively large amount of light is incident on the image sensor 12 and reliable detection of the alignment marks 36 and 38 becomes possible.

In the meantime, in the embodiment of the present invention, the alignment marks 36 and 38 may be implemented as a set of a plurality of line segments or points, rather than as lines of a polygon or a solid shape. For example, the alignment marks 36 and 38 may be implemented by disposing predetermined sized points at the vertex positions of a triangle or square.

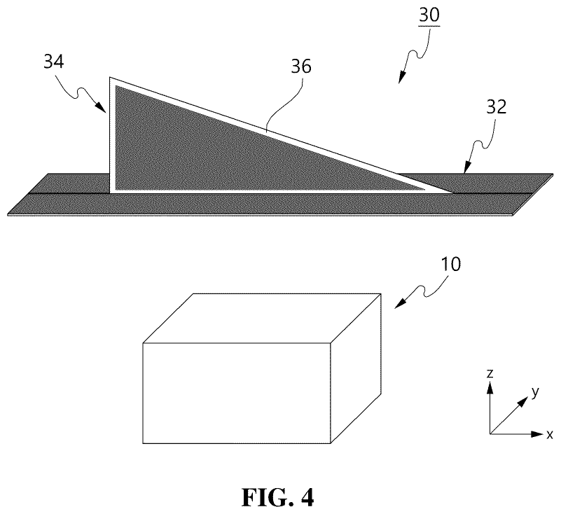

FIG. 4 is a diagram illustrating an example of a disposition configuration for performing target alignment of the golf launch monitor according to the embodiment of the present invention.

Referring to FIG. 4, after installing the golf launch monitor 10 on the ground, the alignment jig 30 is disposed in front of the image sensor 12 of the golf launch monitor 10 to face the target direction of in which the golf ball is to be hit.

When the ground has an even plane, the golf launch monitor 10 and the base 32 of the alignment jig 30 may be placed on the same X-Y plane. However, when the slope of the ground on which the golf launch monitor 10 is placed has a different slope than the ground on which the alignment jig 30 is placed, the ground on which the golf launch monitor 10 is placed and the ground on which the alignment jig 30 is placed are in different planes. However, the present invention has the advantage of utilizing alignment marks 36 and 38 that are disposed on the plane of the alignment panel 34 to enable target alignment in various environments, and to enable more accurate golf ball launch monitoring by using the target alignment result. For example, when the golf launch monitor 10 is positioned horizontally while the alignment jig 30 is positioned at a slope, the launch monitoring of the golf ball may reflect the tendency of the golf ball to hook or slice, depending on the disposition state.

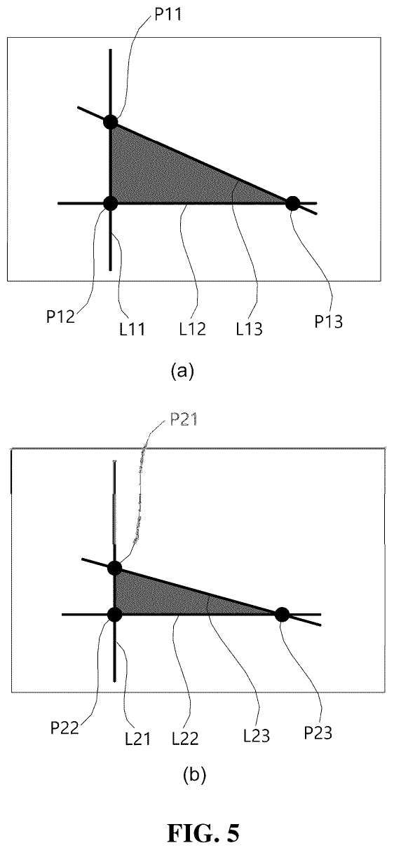

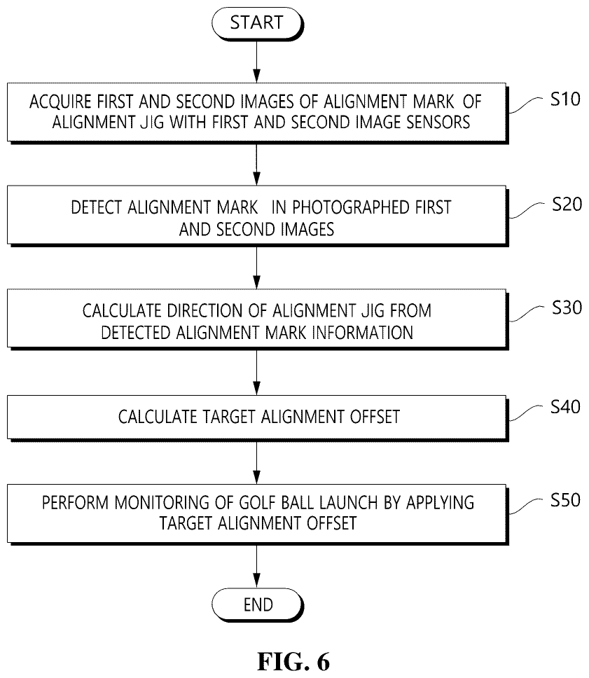

FIG. 5 is a diagram illustrating an example of image processing for performing target alignment of the golf launch monitor according to the embodiment of the present invention, and FIG. 6 is a flowchart illustrating a target alignment method of the golf launch monitor according to an embodiment of the present invention.

FIGS. 5 and 6 illustrate target alignment by using the alignment marks 36 and 38 formed as triangles.

For the target alignment of the golf launch monitor 10, the golf launch monitor 10 is disposed on the ground and the alignment jig 30 is disposed in front of the golf launch monitor 10 (in front of the image sensor 12).

The golf launch monitor 10 acquires a first image and a second image of the alignment marks 36 and 38 of the alignment jig 30 from the first image sensor 12a and the second image sensor 12b, respectively (S10). (a) of FIG. 5 illustrates an example of the first image, and (b) of FIG. 5 illustrates an example of the second image.

The processor 14 detects an alignment mark in the photographed first image and second image (S20).

In the embodiment, the processor 14 binarizes the images by using predetermined thresholds for the first image and the second image. For each binarized image, an image processing technique, such as the Hough Transform, is applied to detect the straight lines L11, L12, L13; L21, L22, and L23 that configure the alignment mark and calculate intersection points P11, P12, P13; P21, P22, and P23 of the straight lines L11, L12, L13; L21, L22, and L23. The intersection points P11, P12, P13; P21, P22, and P23 of the straight lines L11, L12, L13; L21, L22, and L23 (i.e., the vertices of the polygon) may be represented by two-dimensional coordinates.

FIG. 5 illustrates all of the straight lines forming the triangle and the intersection points of the straight lines, but in an embodiment of the present invention, identifying at least two straight lines and the intersection points of the straight lines may calculate three-dimensional coordinates of a particular intersection point to calculate a direction of the alignment jig 30.

The processor 14 may calculate the three-dimensional coordinates of the intersection points in the space by applying a triangulation technique to the first image and the second image as stereo images, by using the coordinates of the intersection points in the first image and the second image and the calibration parameters of the first image sensor 12a and the second image sensor 12b that configure the stereo camera.

The processor 14 calculates the direction of the alignment jig 30 (i.e., the direction of the aimed target line 2) by using the information of the alignment mark detected in operation S20. By comparing the information of the alignment mark detected in the images of the alignment jig 30 acquired by the first and second image sensors 12a and 12b with the information of the actual alignment mark, the direction of the alignment jig 30 may be calculated.

In the embodiment, the processor 14 generates a two-dimensional template image of the alignment marks 36 and 38 by using the three-dimensional coordinates of the intersection point of the alignment marks 36 and 38 calculated in operation S20, dimensional information, such as the actual size and angle, of the alignment marks 36 and 38 that is already known, and the calibration parameters of the first and second image sensors 12a and 12b.

Specifically, the processor 14 may define an arbitrary triangle based on the coordinates of the intersection points (vertices) of the alignment marks 36 and 38 in the three-dimensional coordinate space by using predefined angles and dimensions on both sides of the intersection points. Here, the normal direction of the plane containing the triangle in the three-dimensional coordinate space may be limited to a predetermined range relative to the direction of the reference target line 1 of the golf launch monitor 10. Furthermore, the position of the triangle may also be limited in a predetermined range based on the initially calculated three-dimensional coordinates of the intersection point of the triangle.

As described above, based on the three-dimensional coordinates of the vertices of the polygon and the direction of the reference target line 1 of the golf launch monitor 10, various triangles having a position and direction change within a predetermined range in the three-dimensional space may be defined, and by projecting the above-defined triangle into two-dimensional space through the calibration parameters of the image sensor 12, two-dimensional template images of the triangles in three-dimensional space may be generated. In a next operation, the generated template images and the polygonal images acquired by the first and second image sensors 12a and 12b may be matched through a template matching technique to determine a template image with the highest matching degree, and the direction angle of the triangle in the three-dimensional space corresponding to the corresponding template image may be determined as a direction angle of the polygonal alignment jig.

On the other hand, when the alignment marks 36 and 38 is formed of a set of a plurality of line segments or points rather than a polygon, the processor 14 may perform operations S20 and S30 by detecting the plurality of line segments or the set of points instead of the intersection points of the polygon.

The processor 14 may calculate a target alignment offset according to an angular difference between the direction of the aimed target line 2 and the direction of the reference target line 1 (S40).

The processor 14 may apply the target alignment offset to monitor the golf ball launch in response to a hit of the golf ball (S50).

The processor 14 of the golf launch monitor 10 described above may be implemented in software, or may be implemented in hardware. If the processor 14 of the golf launch monitor 10 is implemented in software, the CPU may execute a computer program to perform various functions. The program may be stored in an embedded memory or on a non-transitory computer-readable recording medium. The processor 14 of the golf launch monitor 10 may also be realized by so-called cloud computing by reading a program stored on an external recording medium. If the processor 14 of the golf launch monitor 10 is implemented in hardware, the program may be realized by various circuits, such as ASICs, FPGAs or DRPs. In the present embodiment, various information or concepts including various information are described, but they are represented by a set of binary bits consisting of 0 or 1, which are represented by a high or low signal value, and communication or computation may be performed by any of the above software or hardware modalities.

Although the exemplary embodiment of the present disclosure has been described for illustrative purposes, those skilled in the art will appreciate that various modifications, additions and substitutions are possible, without departing from the essential characteristic of the invention. Therefore, the exemplary embodiments disclosed in the present disclosure and the accompanying drawings are not intended to limit the technical spirit of the present disclosure, but are intended to illustrate the scope of the technical idea of the present disclosure, and the scope of the present disclosure is not limited by the exemplary embodiment and the accompanying drawings. The scope of the present disclosure shall be construed on the basis of the accompanying claims in such a manner that all of the technical ideas included within the scope equivalent to the claims belong to the scope of the present disclosure.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and 10 applications which do not depart from the spirit and scope of the invention are deemed to be covered by the invention which is limited only by the claims which follow.

What is claimed is:

1. A target alignment method of a golf launch monitor using an alignment jig including a two-dimensional alignment mark placed in front of the golf launch monitor, the target alignment method comprising:
(a) acquiring a first image and a second image including the alignment mark with a first image sensor and a second image sensor, respectively;
(b) detecting, by a processor, the alignment mark in the first image and the second image, respectively; and
(c) calculating, by the processor, an aimed target line according to the alignment jig by using the detected alignment mark and calibration parameters of the first image sensor and the second image sensor.

2. The target alignment method of claim 1, wherein the alignment jig includes a base that is seated on the ground and an alignment panel fixed to an upper portion of the base and including the alignment mark.

3. The target alignment method of claim 2, wherein the alignment mark is formed of a reflective material or a reflective sheet.

4. The target alignment method of claim 1, further comprising:
(d) calculating, by the processor, a target alignment offset based on a difference between a direction of the aimed target line and a reference target line of the golf launch monitor.

5. The target alignment method of claim 1, wherein the alignment mark has a predetermined polygonal shape, and the operation (b) is performed by detecting at least two straight lines forming the polygon and an intersection point of the two straight lines, and calculating three-dimensional coordinates of the intersection point.

6. The target alignment method of claim 1, wherein the alignment mark is formed of a set of a plurality of line segments or a plurality of points.

7. A golf launch monitor using an alignment jig including a two-dimensional alignment mark placed in front of the golf launch monitor, comprising:
a first image sensor and a second image sensor configuring a stereo camera; and
a processor configured to perform the following steps;
(a) acquiring a first image and a second image including the alignment mark with a first image sensor and a second image sensor, respectively;
(b) detecting the alignment mark in the first image and the second image, respectively; and
(c) calculating an aimed target line according to the alignment jig by using the detected alignment mark and calibration parameters of the first image sensor and the second image sensor.

8. The golf launch monitor of claim 7, wherein the alignment jig includes a base that is seated on the ground and an alignment panel fixed to an upper portion of the base and including the alignment mark.

9. The golf launch monitor of claim 7, wherein the alignment mark is formed of a reflective material or a reflective sheet.

10. The golf launch monitor of claim 7, wherein the processor is further configured to perform:
(d) calculating a target alignment offset based on a difference between a direction of the aimed target line and a reference target line of the golf launch monitor.

11. The golf launch monitor of claim 7, wherein the alignment mark has a predetermined polygonal shape, and the operation (b) is performed by detecting at least two straight lines forming the polygon and an intersection point of the two straight lines, and calculating three-dimensional coordinates of the intersection point.

12. The golf launch monitor of claim 7, wherein the alignment mark is formed of a set of a plurality of line segments or a plurality of points.
